(19) United States
(12) Patent Application Publication
(10) Pub. No.: US 2007/0248808 A1
(43) Pub. Date: Oct. 25, 2007

(54) Passivation film for electronic device and method of manufacturing the same

(75) Inventors: Ho-nyeon LEE, Seongnam-si (KR); Young-gu LEE, Suwon-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/548,839

(22) Filed: Oct. 12, 2006

(30) Foreign Application Priority Data
Apr. 21, 2006 (KR) 10-2006-0036407

(51) Int. Cl. B32B 3/26

(52) U.S. Cl. 428/319.1; 428/316.6

(57) ABSTRACT

A passivation film for protecting an electronic device includes a porous material layer formed to cover the electronic device and an inorganic passivation layer formed on the porous material layer.

This application claims priority to Korean Patent Application No. 10-2006-0036407, filed on Apr. 21, 2006, and all the benefits accruing therefrom under 35 U.S.C. §119, the contents of which in its entirety are herein incorporated by reference.

### BACKGROUND OF THE INVENTION

1. Field of the Invention

The present invention relates to a passivation film and a method of manufacturing the same, and more particularly, to a passivation film for an electronic device in which the passivation film can be manufactured using a simple method.

2. Description of the Related Art

In general, an electronic device such as an organic light emitting device (“OLED”) require a passivation element for protecting the electronic device from external moisture or oxygen since the lifetime of the electronic device is reduced when the electronic device is exposed to moisture or oxygen. Conventionally, to protect an OLED, the OLED is sealed using glass. However, there are drawbacks with using glass to seal the OLED as the glass increases the thickness of a display device and the glass cannot be used for a flexible display device.

FIG. 1 is a cross-sectional view of a passivation film for an OLED 160 disclosed in U.S. Pat. No. 6,268,695 as a method of solving the above problems with using glass to seal the OLED. Referring to FIG. 1, to prevent the OLED 160 from being exposed to external moisture or oxygen, a passivation film for the OLED 160 has a structure in which a plurality of organic passivation layers 142, 132 and 136 and inorganic passivation layers 144 and 134 are alternately stacked on the OLED 160. Here, the organic passivation layers 142, 132 and 136 can be formed of a polymer, and the inorganic passivation layers 144 and 134 can be formed of a ceramic. In a structure in which the organic passivation layers 142, 132 and 136 and the inorganic passivation layers 144 and 134 are alternately stacked, the organic passivation layers 142, 132 and 136 prevent defects from being generated in the inorganic passivation layers 144 and 134. More specifically, when thin films of different kinds of passivation layers are bonded to each other, stresses are generated in a direction of expanding or shrinking of the thin films, with respect to each other. At this time, when one of the contacted thin films is formed of a material that is easily shrunk or expanded by an external force such as an organic polymer, the organic passivation layers 142, 132 and 136 relieve stresses by changing a shape thereof. That is, when the inorganic passivation layers 144 and 134 directly contact the OLED 160 or other inorganic passivation layers 144 and 134, stresses are increased in the inorganic passivation layers 144 and 134, thereby causing a defect like a crack. At this time, the organic passivation layers 142, 132 and 136 formed between the inorganic passivation layers 144 and 134 relieve stresses in the inorganic passivation layers 144 and 134, thereby preventing the cause of defects in the inorganic passivation layers 144 and 134.

However, to manufacture the passivation film for an OLED having the above structure, the number of processes is increased since a plurality of organic passivation layers 142, 132 and 136 and a plurality of inorganic passivation layers 144 and 134 must be stacked.

### BRIEF SUMMARY OF THE INVENTION

According to an aspect of the present invention, the present invention provides a passivation film for an organic light emitting device (“OLED”) and a method of manufacturing the same.

An exemplary embodiment of a passivation film for protecting an electronic device includes a porous material layer formed to cover the electronic device, and an inorganic passivation layer formed on the porous material layer.

The passivation film may further comprise at least one porous material layer and one inorganic passivation layer alternately stacked on the inorganic passivation layer.

The electronic device may be an OLED that comprises an anode, an emitting material layer (“EML”) and a cathode. Here, the porous material layer and the inorganic passivation layer may be alternately stacked on the cathode. Also, the porous material layer and the inorganic passivation layer may be alternately stacked on the anode.

The porous material layer may be formed of at least one material selected from the group consisting of porous silicon, porous methyl silsesquioxane (“porous MSSQ”), mesoporous silica and porous xerogel.

The inorganic passivation layer may be formed of a ceramic.

According to another exemplary embodiment of the present invention, there is provided a method of manufacturing a passivation film for protecting an electronic device. The method includes forming a porous material layer covering the electronic device, and forming an inorganic passivation layer on the porous material layer.

The method may further comprise alternately forming at least one porous material layer and one inorganic passivation layer on the inorganic passivation layer after the inorganic passivation layer is formed.

### BRIEF DESCRIPTION OF THE DRAWINGS

The above and other aspects, features and advantages of the present invention will become more apparent by describing in more detail exemplary embodiments thereof with reference to the attached drawings in which:

FIG. 1 is a cross-sectional view of a conventional passivation film for an organic light emitting device (“OLED”);

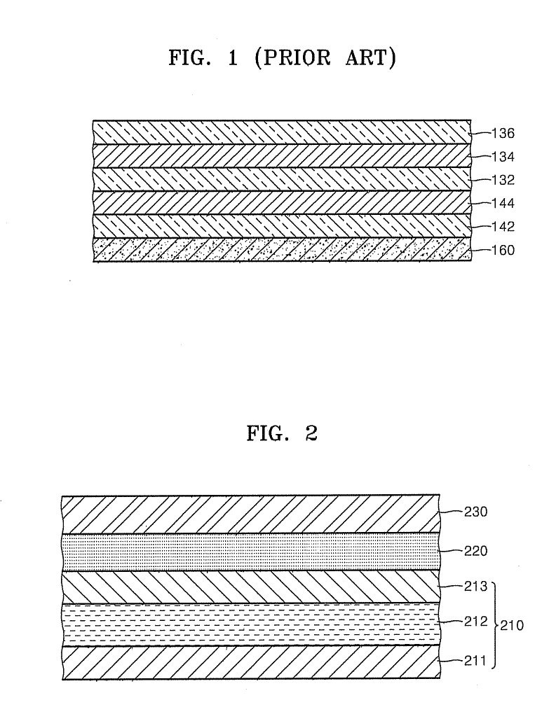

FIG. 2 is a cross-sectional view of a passivation film for an OLED according to an exemplary embodiment of the present invention; and

FIGS. 3A through 3C are cross-sectional views illustrating a method of manufacturing a passivation film for an OLED according to an exemplary embodiment of the present invention.

### DETAILED DESCRIPTION OF THE INVENTION

A passivation film according to the present invention can extend a lifetime of an electronic device by preventing exposure of the electronic device to external moisture or oxygen by sealing the electronic device. The present invention can be applied to various electronic devices that can be damaged by being exposed to external moisture or oxygen, and a representative example is an organic light emitting device (“OLED”). Hereinafter, an OLED will be described as an example of the electronic device.

The present invention now will be described more fully hereinafter with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath”can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

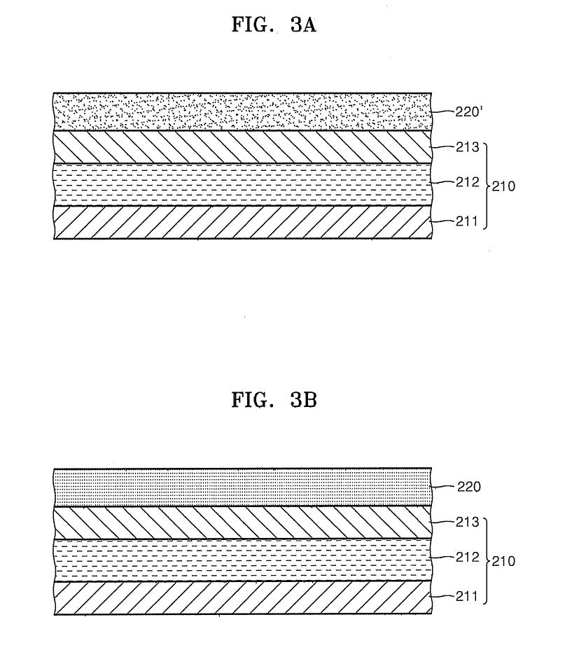

FIG. 2 is a cross-sectional view of a passivation film for an OLED according to an exemplary embodiment of the present invention.

Referring to FIG. 2, an OLED 210 is provided as an electronic device. The OLED 210 has a structure in which an anode 211, an emitting material layer (“EML”) 212 formed of an organic material and a cathode 213 are sequentially stacked. Although it is not shown, a substrate is provided on a lower surface of the anode 211. Here, the substrate can be a glass substrate or a plastic substrate. A hole injection layer (“HIL”) (not shown) may be further formed between the anode 211 and the EML 212, and also an electron injection layer (“EIL”) (not shown) may be further formed between the EML 212 and the cathode 213.

A porous material layer 220 and an inorganic passivation layer 230 are sequentially formed on the OLED 210. The porous material layer 220 is formed to cover the cathode 213 of the OLED 210, and the inorganic passivation layer 230 is formed on an upper surface of the porous material layer 220. In FIG. 2, the porous material layer 220 and the inorganic passivation layer 230 are respectively formed in one layer on the OLED 210, but the present invention is not limited thereto. That is, the porous material layer 220 and the inorganic passivation layer 230 respectively may be formed in multiple layers. In this case, a plurality of porous material layers 220 and the inorganic passivation layers 230 may be alternately stacked.

The inorganic passivation layer 230 seals the OLED 210 so that the OLED 210 cannot be exposed to external moisture or air. The inorganic passivation layer 230 can be formed of a ceramic, for example, silicon oxide, silicon nitride, metal oxide, metal nitride, metal carbide and metal oxynitride, but is not limited thereto. The inorganic passivation layer 230 can also be formed of other materials besides ceramic.

The porous material layer 220 prevents the generation of defects in the inorganic passivation layer 230 stacked thereon. When the inorganic passivation layer 230 directly contacts the OLED 210 or another inorganic passivation layer 230, stresses can be increased in the inorganic passivation layer 230, thereby generating cracks in the inorganic passivation layer 230. Therefore, in the present exemplary embodiment, the generation of defects in the inorganic passivation layer 230 can be prevented by forming the porous material layer 220 on an upper surface of the OLED 210 or between the inorganic passivation layers 230. That is, the porous material layer 220 can be readily deformed due to pores in the porous material layer 220 when an external force is applied thereto. Therefore, stresses caused in the inorganic passivation layer 230 stacked thereon can be effectively removed, thereby preventing the generation of defects in the inorganic passivation layer 230.

The porous material layer 220 can be formed of at least one material selected from the group consisting of porous silicon, porous methyl silsesquioxane (“porous MSSQ”), mesoporous silica and porous xerogel, for example, but is not limited thereto. The porous material layer 220 can also be formed of various materials besides the above materials.

The above descriptions refer to the case of forming the porous material layer 220 and the inorganic passivation layer 230 on an upper surface of the OLED 210, that is, only on an upper surface of the cathode 213, but the porous material layer 220 and the inorganic passivation layer 230 may be further formed on a lower surface of the OLED 210, that is, on a lower surface of the anode 211.

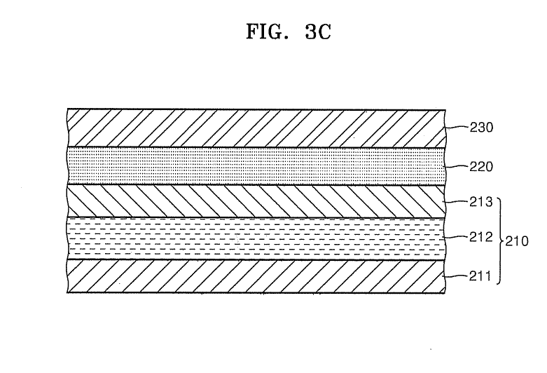

Hereinafter, a method of manufacturing a passivation film for an electronic device according to another exemplary embodiment of the present invention will be described with reference to FIGS. 3A through 3C. FIGS. 3A through 3C are cross-sectional views of a method of manufacturing a passivation film for an OLED according to an exemplary embodiment of the present invention.

Referring to FIG. 3A, an amorphous silicon layer 220′ covering an OLED 210 including an anode 211, an EML 212 and a cathode 213 is formed. Referring to FIG. 3B, the amorphous silicon layer 220′ is transformed into a porous silicon layer 220 using an anodization method. That is, the amorphous silicon layer 220′ transforms into the porous silicon layer 220 when the amorphous silicon layer 220′ is anodized using the cathode 213 as an electrode.

Next referring to FIG. 3C, an inorganic passivation layer 230 is formed on an upper surface of the porous silicon layer 220. Here, the inorganic passivation layer 230 can be formed by depositing a ceramic using a vacuum deposition method such as a chemical vapour deposition (“CVD”) method, a plasma enhanced vapour deposition (“PECVD”) method, a sputtering method, or an electron beam evaporation method. The inorganic passivation layer 230 can also be formed of an inorganic material besides ceramic.

In FIGS. 3A through 3C, the porous silicon layer 220 and the inorganic passivation layer 230 are respectively formed in single layers, but a plurality of porous silicon layer 220 and inorganic passivation layers 230 may be formed on the OLED 210. In this case, the porous silicon layer 220 and the inorganic passivation layers 230 may be alternately stacked. Also, the porous silicon layer 220 and the inorganic passivation layer 230 may be further formed on a lower surface of the OLED 210, that is, on a lower surface of the anode 211.

The above descriptions refer to the case of forming the porous silicon layer 220 of the porous material layer using an anodization method, but the porous material layer can be formed to cover an upper surface of the OLED 210 using a vacuum deposition method or a spin coating method. Here, the porous material layer may be formed of porous MSSQ, mesoporous silica, or porous xerogel.

In the above exemplary embodiment, an OLED is explained as a representative example of an electronic device, but the present invention is not limited thereto. That is, the present invention can be applied to electronic devices that are required to be protected from an external environment, and more specifically, to electronic devices whose lifespan can be reduced by becoming defective when exposed to external moisture or oxygen.

As described above, according to the present invention, an electronic device can be protected from an external environment by alternately stacking at least one porous material layer and one inorganic passivation layer on the electronic device, thereby preventing the cause of defects in the inorganic passivation layer. Also, the passivation film can be readily formed using a simple process when a porous material layer and an inorganic passivation layer are respectively formed in one single layer on an electronic device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A passivation film for protecting an electronic device, comprising:
a porous material layer formed to cover the electronic device; and
an inorganic passivation layer formed on the porous material layer.

2. The passivation film of claim 1, further comprising at least one porous material layer and one inorganic passivation layer alternately stacked on the inorganic passivation layer.

3. The passivation film of claim 1, wherein the electronic device is an organic light emitting device (OLED) that comprises an anode, an emitting material layer (EML) and a cathode.

4. The passivation film of claim 3, wherein the porous material layer and the inorganic passivation layer are alternately stacked on the cathode.

5. The passivation film of claim 4, wherein the porous material layer and the inorganic passivation layer are alternately stacked on the anode.

6. The passivation film of claim 1, wherein the porous material layer is formed of at least one material selected from the group consisting of porous silicon, porous methyl silsesquioxane (porous MSSQ), mesoporous silica and porous xerogel.

7. The passivation film of claim 1, wherein the inorganic passivation layer is formed of a ceramic.

8. A method of manufacturing a passivation film for protecting an electronic device, the method comprising:
forming a porous material layer covering the electronic device; and
forming an inorganic passivation layer on the porous material layer.

9. The method of claim 8, further comprising alternately forming at least one porous material layer and one inorganic passivation layer on the inorganic passivation layer after the inorganic passivation layer is formed.

10. The method of claim 8, wherein the electronic device is an OLED that comprises an anode, an EML and a cathode.

11. The method of claim 8, wherein the porous material layer is formed of at least one material selected from the group consisting of porous silicon, porous MSSQ, mesoporous silica and porous xerogel.

12. The method of claim 8, wherein the forming of the porous material layer comprises:
forming an amorphous silicon layer covering the electronic device; and
transforming the amorphous silicon layer into a porous silicon layer by anodizing the amorphous silicon layer.

13. The method of claim 8, wherein the porous material layer is formed using one of a vacuum deposition method and a spin coating method.

14. The method of claim 8, wherein the inorganic passivation layer is formed using a vacuum deposition method.
